(19) United States
(12) Patent Application Publication
(10) Pub. No.: US 2009/0321413 A1
(43) Pub. Date: Dec. 31, 2009

(54) DISPLAY DEVICE FOR A HOB, HOB AND METHOD OF OPERATING SUCH A DISPLAY DEVICE

(75) Inventors: Christian Egenter, Bretten (DE); Wilfried Schilling, Kraichtal (DE); Tobias Schoenherr, Kraichtal (DE); Martin Volk, Baden-Baden (DE); Uwe Winkler, Ettlingen (DE)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: E.G.O. Elektro-Geraetebau GmbH

(21) Appl. No.: 12/470,828

(22) Filed: May 22, 2009

(30) Foreign Application Priority Data
Jun. 2, 2008 (DE) 102008027220.5

(51) Int. Cl. H05B 3/68; G08B 5/36

(52) U.S. Cl. 219/452.11; 340/691.6

(57) ABSTRACT

A hob comprising a plurality of heating elements further comprises a support for a plurality of illuminating means, said support being of elongate construction and typically arcuate in shape. In one embodiment, two rows of illuminaries in the form of LEDs are provided wherein a cover with light zones is positioned thereover. The cover may indicate various symbols and letters to a user of the hob. Separate light zones may be defined to prevent light from one illuminary zone spilling over to the next illuminary zone. A controller may illuminate one row of illuminaries indicating the heating element is hot, even after power is removed from the heating element, and illuminate another row indicating a level of operation of the heating element. The hob may comprise a plurality of heating elements each having an associated illuminating means located in front of the heating area facing the operator.

### CROSS REFERENCE TO RELATED APPLICATIONS

This application claims priority to German Patent Application 102008027220.5, filed on Jun. 2, 2008, the contents of which are incorporated by reference.

### FIELD OF INVENTION

The invention relates to a display device for a hob, a hob with a plurality of such display devices and a method of operating such a display device.

### BACKGROUND

It is known from DE 3722632 A1 to provide a hob, next to the rings thereof, with display devices with a plurality of light segments. The light segments are actuated as a function of the rotated position of a mechanical thermostat via an additional switching means in such a way that a given light segment is illuminated as a function of a preselected temperature for a ring. Lettering representing a specific function or temperature is provided over each light segment. Illuminating this lettering displays to an operator what temperature or function is set for the adjacent ring.

It is known from U.S. Pat. No. 7,247,821 to provide an elongate, strip-like display device in the manner of an illuminated display on the front of a cooker with hob and oven. This display device comprises a plurality of light segments arranged next to one another. The temperature of the oven, for example, may be represented by the length or number of the illuminated light segments.

It is known from EP 1 213 543 A1 to arrange an arc shaped display device with a plurality of LEDs as illuminating means in the form of an arc of a circle in front of a hob ring. The power setting of the relevant ring may for example be indicated by the number of LEDs illuminated.

### SUMMARY

One problem address by the present invention is that of providing an above-mentioned display device for a hob, a hob provided therewith and an operating method, with which prior art problems may be solved and in particular an advantageous display device provided with additional functions may be obtained.

This problem is solved in one embodiment by a display device having the features of claim 1, a hob having the features of claim 18 and a method having the features of claim 19. Advantageous and preferred developments of the invention are the subject matter of the further claims and are explained in greater detail below. Some of the features are explained solely with reference to a display device, a hob or an operating method, but they may irrespectively also apply to the others. The wording of the claims is incorporated by express reference into the content of the description.

Provision is made for the display device to comprise a support for a plurality of illuminating means, said support being of elongate construction. According to on embodiment of the invention, the illuminating means extend next to each other in two rows, the rows in particular being arranged parallel to one another. Over at least a first row of illuminating means there is provided a cover with light-transmitting zones, which take the form of symbols and/or letters, this cover preferably extending over all the illuminating means of this first row. Apart from these light-transmitting zones in the form of symbols, the cover over this first row of illuminating means is opaque. Moreover, separators are provided between the illuminating means of this first row, which separators prevent light from one illuminating means from spilling over to a light-transmitting zone above an adjacent or other illuminating means. This ensures that one illuminating means actually illuminates only the desired light-transmitting zone associated therewith and no other undesired zone.

It is thus possible with the illuminating means of this first row to light up particular displays or symbols. The illuminating means of the second row may then serve other purposes, as explained below in greater detail in relation to various embodiments.

In a further embodiment of the invention, the illuminating means in the first row, with the partially light-transmitting and otherwise opaque cover there-over, are spaced from one another by a distance corresponding to for instance two to five times their extent. This makes it possible, in particular in the case of illuminating means in the form of LEDs or particularly advantageously SMD LEDs, to make the distance between the illuminating means so great that the illuminated symbols there above are sufficiently large and easily recognizable for an operator. In a particularly preferred configuration of the invention all the illuminating means in this first row are at an identical distance from one another, this also being possible for the light-transmitting zones in the form of symbols arranged there over.

In a second row, illuminating means, which are preferably the same as in the first row, may be at the same distance from one another as those of the first row. A cover is likewise advantageously arranged over this second row of illuminating means, which is however substantially light-transmitting or at least translucent. This translucency may, as also with the light-transmitting zones in the form of symbols over the first row of illuminating means, be designed to provide a type of diffuser effect for the light of the LEDs there below. This results in uniform, pleasant light distribution or illumination of the respective zones. The cover may take the form of a type of thick film of plastics, for example with a thickness of less than 1 mm, possibly with a thickness of around 0.3 mm. Furthermore, the cover is advantageously provided as a single component for all the illuminating means. To this end, it may comprise zones which are in each case different. Different light transmittance may be achieved for example by a multi-component production method. Alternatively, opaque zones may be achieved by printing with opaque color or the like. The cover may be fastened, for example adhesively bonded, on the top of the housing during production of the display device.

In a further embodiment of the invention it is possible to configure the separators between the illuminating means of the second row in such a way that slight spill-over from one illuminating means to a light-transmitting zone over an adjacent illuminating means is possible. In this way, more uniform, better distributed illumination of the second row is possible. This is particularly advantageous if this second row is constructed and used as a continuous light strip or as a strip illuminated over one piece thereof.

The support is advantageously a flat component support, in particular a printed circuit board. A housing with the above-stated separators is positioned thereon, the housing forming with the separators in each case a type of light duct. The above-stated cover is positioned on the top of this housing. The housing with the light ducts and the separators there between may thus take the form of a type of grid. Advantageously, to make the housing more stable, an externally surrounding housing wall is made thicker, while the separators may be made even relatively thin if an appropriate choice of a suitable plastics is made, in order to achieve the desired opacity between adjacent light ducts.

In a further embodiment, the housing may be constructed such that it substantially covers or surrounds the illuminating means on the support. This provides screening against undesired lateral escape of the light. The structural unit comprising support, illuminating means and housing and optionally cover is thus constructed to be light-proof other than in the desired illumination direction upwards along the light ducts. It is then possible for the housing to grip over the support at least at the longitudinal sides of the device so as reliably to prevent undesired lateral escape of light.

The housing is advantageously of one-piece construction and joined to the cover, for example, undetachably to form a structural unit. It may be attached to, or on, the support in various ways, for example, by clipping on using mechanical retention devices, which may under certain circumstances, be of detachable construction.

Advantageously, support and also housing and thus the entire display device are of curved or arc shaped (“arcuate”) construction. This curvature may in particular be uniform. This allows a degree of adaptation from the point of view of shape to conventionally round hob rings. If, in the case of a hob according to the invention, a plurality of rings are each provided with such a display device according to the invention, it is regarded as sufficient for all the display devices to be of identical construction. Then, although the curvature or degree of rounding of the display devices cannot be conformed precisely to the external shape of the rings, which are conventionally of different sizes, this is not regarded as particularly problematic, in particular because the display devices may be at a distance of at least a few millimeters from a ring.

In a further embodiment of the invention, a display device may comprise a control unit, in particular a microcontroller. This control unit may serve to connect the display device to a central control unit of a hob for communication purposes, in particular to a control bus provided therein. For instance, an above-mentioned central control unit of a hob may thus change the display status on the display device as a function of control commands, which may in turn depend on the operating states of the respective ring or indeed on different operator inputs or operations. Such a bus connection of the display device to a control bus of the hob is particularly advantageously of bidirectional construction, such that it is possible for the hob control unit both to change the display status on the display device and in each case to be informed as to what is actually displayed.

In a still further embodiment of the invention, provision may be made for the device also to comprise a seven segment display. In this way, additional information may be displayed, for example, as is generally known with display devices on hobs or the like.

In one embodiment of the invention, an overlap sensor may be provided on the display device, for example in the manner of a reflection light barrier, which is directed or acts in an upward direction. Alternatively, such a sensor may also operate capacitively or inductively, for example as a per se known pan detection sensor. In this way it is possible to detect whether a pan or other object has been placed thereon which limits or prevents the display device from being perceived or seen. Then a corresponding warning signal may be output, for example after feedback from the display device to a central control unit of the hob via the above-stated control bus, so that the operator's attention is drawn to this incorrect state.

As an alternative or in addition to an above-stated overlap sensor, a temperature sensor may be provided on the display device, which is also oriented in particular upwards. This is intended to make it possible to detect whether a possibly very hot pan has been placed over the display device or displaced thereover, the inherent heat of which acts or radiates downwards through the hob plate onto the display device in such a way that the latter could be damaged. Such a temperature sensor may either be a simple resistance sensor element or indeed detect the temperature prevailing over the display device by way of thermal radiation. Under certain circumstances it is even possible to provide both the above-stated function of an overlap sensor and that of a temperature sensor or possibly combine them in one sensor unit.

In a still further embodiment of the invention, one or more spacers may be provided on the top of the display device. These may ensure that the display device is arranged at a given, precisely defined distance below a hob plate. This is advantageous particularly in the case of conventionally bumpy undersides to these hob plates, since in this case a certain distance is regarded as advantageous in order to make the illuminated image uniform and visually attractive. These spacers may advantageously project above the above-stated cover with diffuser effect. They may for example be formed as protruding noses on the above-stated housing. As an extra function, they may also ensure precise fixing of the position of the stated cover relative to the housing. The spacers should ensure a distance of 0.1 to 1 mm, in particular for instance 0.5 mm, from the underside of the hob plate and thus protrude by this amount above the top of the cover.

These and further features follow not only from the claims but also from the description and the drawings, the individual features being realized in each case alone or several together in the form of sub-combinations in an embodiment of the invention and in other fields and may constitute advantageous, per se protectable embodiments, for which protection is here claimed. Subdivision of the application into individual sections and intermediate headings does not limit the general applicability of the statements made thereunder.

### BRIEF DESCRIPTION OF THE DRAWINGS

An exemplary embodiment of the invention is illustrated schematically in the drawings and explained in greater detail below. In the drawings:

FIG. 1 illustrates is an oblique view of a display device according to one embodiment of the invention, viewed obliquely from above,

FIG. 2 illustrates an exploded representation of the display device of FIG. 1,

FIG. 3 is a plan view of the display device of FIG. 1 in a partially activated state, and

FIG. 4 illustrates a hob according to the invention with four rings and in each case one display device corresponding to FIG. 1 per ring.

### DETAILED DESCRIPTION

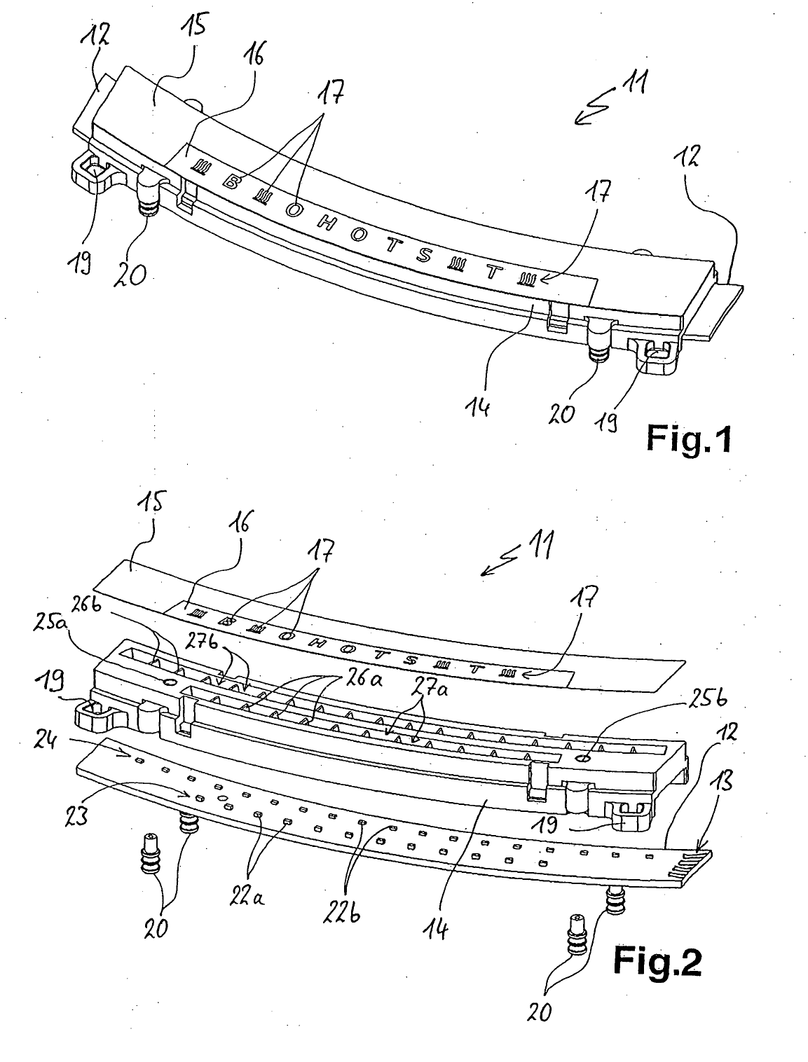

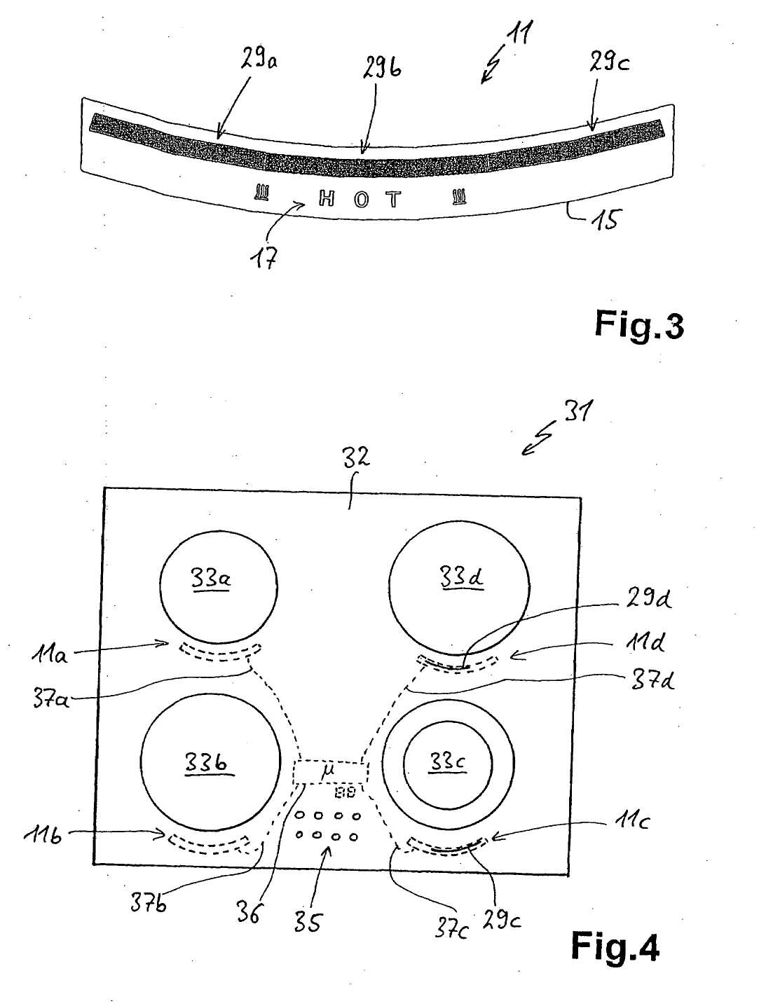

FIG. 1 shows a display device 11 according to the invention in the assembled state as a finished structural unit, while the exploded view of FIG. 2 shows it dismantled into its individual parts. As is clear from the plan view of FIG. 3, the display device 11 is elongate and curved slightly, while exhibiting a roughly constant width. The display device 11 comprises a support 12 of this basic shape, which may in particular be a printed circuit board. On the right-hand side on the support 12 lines show by way of example how electrical connections 13 may be configured, namely as it were as fields for multiconnectors for plugging a corresponding mating connector thereon according to FIG. 1 at the rightwardly protruding end of the support 12.

A correspondingly constructed housing 14 of plastics is placed on the support 12, the construction of which is more clearly visible from FIG. 2 and is described below in greater detail. This housing 14 bears at the top a cover 15, which is likewise apparent from FIG. 2. The cover 15 takes the form of a basically light-transmitting but translucent thick film or thin plastics layer. It comprises a symbol zone 16 in its front region, which is in turn opaque apart from light-transmitting symbols 17. This opacity may be brought about by coating the symbol zone 16 while omitting the symbols 17. Thus, light may be radiated from below through both the symbols 17 and the rest of the surface area of the cover 15 and this illumination may be perceived from above. In these light-transmitting or translucent zones 17, the cover 15 may act to a degree as a diffuser, which gives the light a more uniform, more visually attractive appearance. This is known in principle, however.

The housing 14 comprises fastening eyelets 19 constructed integrally therewith and rubber feet 20 attachable close thereto. Thus, a possible way of fastening the display device 11 may involve fixing thereof by pins engaging in the eyelets with simultaneous pressure or resilient mounting as a result of the rubber feet 20 upwards against a hob plate corresponding to FIG. 4 extending thereover.

A plurality of LEDs are arranged on the support 12, specifically in one case twelve LEDs 22a, which form a first row 23 matching the curvature of the support 12. In addition, eighteen LEDs 22b are arranged parallel thereto and form the parallel second row 24 of LEDs, which extend somewhat beyond the first row 23 on both the left and right. The number of LEDs 22a or 22b may vary. In addition it is also possible for an extra third row of LEDs to be provided.

It is clear from FIG. 2 that the spacing both of the LEDs 22a and of the LEDs 22b relative to one another is the same in each case within the rows 23 and 24. Furthermore, the distances between the LEDs of each row are the same in the two rows. These distances amount for instance to five times the length of the LEDs 22, but this may also vary. Furthermore, it is also clear from FIG. 2 that the distances between the LEDs 22a of the first row 23 correspond approximately to the distance between the midpoints of the symbols 17 in the cover 15. Thus in each case, one of the LEDs 22a lies exactly below a symbol 17.

The particular construction of the housing 14 ensures that light ducts 27a formed by separators 26a are associated with each LED 22a of the first row 23. This therefore means that, when the housing 14 has been positioned on the support 12, one LED 22a is situated approximately in the middle of the rectangular light duct 27a and may thus radiate light freely upwards onto the underside of the cover 15 or onto the respective symbols 17. The separators 26a prevent light from spilling over into a light duct 27a of an adjacent LED 22a. Thus each LED 22a has its own light duct, wherein, in a modification of the invention, provision may under certain circumstances also be made for a plurality of LEDs to be provided for each light duct.

Light ducts 27b are provided in corresponding fashion for the LEDs 22b of the second row 24, which light ducts are in each case separated from one another or screened relative to one another by separators 26b. It is best to this end for the separators 26 to extend at the underside of the housing 14 as far as the support 12 or at least very nearly that far. To prevent light from escaping undesirably out of the display device 11 at the longitudinal sides, the housing 14 clearly grips over the support 12, as is visible in FIG. 1. If it is not intended to provide any electrical connections 13 or the like at the ends of the support 12, since electrical connection takes place for example in some other way, the housing may here too extend beyond the support and grip over it.

Unlike over the first row 23 of LEDs 22a with the opaque symbol zone 16 and the light-transmitting symbols 17 thereabove, the cover 15 is uniformly light-transmitting in the strip over the second row 24 of LEDs 22b, but is advantageously again translucent to achieve the above-stated diffuser effect. It is precisely here, since the LEDs 22b shine over an area corresponding to the cross-section of the light duct 27b onto the underside of the cover 15, that the diffuser effect is regarded as advantageous, because then in principle this entire area is seen as shining approximately uniformly upwards. In a further development of the invention it is possible to make the separators 26a and 26b and the other walls of the light ducts 27a and 27b as smooth or reflective as possible, optionally also inclined or in the manner of a parabolic reflector, such that as much as light as possible is radiated upwards from the LEDs 22.

FIG. 2 does not show theoretically possible further electrical or electronic components, arranged for example on the underside of the support 12 opposite the LEDs 22, in particular for actuation of the display device 11. These may comprise for example microcontrollers for actuating the display device 11, for example for an above-stated bus connection to a control bus of an electrical appliance or hob.

FIG. 3 shows a plan view of how for example all the LEDs 22b of the second row 24 are actuated or illuminated, which is intended to be illustrated by the gray shading. The result is an elongate light strip consisting of three light bars 29a, 29b and 29c. The different gray shading is intended to make clear that for example the light bars 29a and 29c shine green or in general in a lighter shade and the middle light bar 29b shines red or in a stronger shade. However, since this entire light bar does not always have to be illuminated over its entire length made up of all the LEDs 22b, but rather is subdivided by the light ducts 27b into eighteen individual light segments, the length of the light strip may vary. Furthermore, any desired light segments may be activated, such that the entire light strip may be lit up for example only in the form of the light bars 29a and 29c or indeed in even smaller subdivisions. Further lighting effects may for example involve periodic variation of the luminance or flashing with a uniform or varying flashing frequency. This may in each case readily be achieved by a person skilled in the art, if it appears appropriate in the circumstances. Likewise, color variations may also be provided, in particular by selecting different colors for the individual LEDs 22b, this also applying to the LEDs 22a of the first row 23. Some illuminating means of one row, in particular the first row, may for example be in permanent operation, preferably in a constant number or with constant operation. Illuminating means of the other row may then for example be operated variably, with different illuminating means being switched on and off, preferably in light strips with a moving light pattern, in the manner of a “running light”. This light strip may travel to and fro, for example, wherein in particular the in each case front region of the light strip with a width of two or three LEDs may shine more brightly than the rear one with more LEDs. Thus, a ring operation display may be provided with which the brightness, rate of motion or length of the light strip advantageously depend on the heat setting.

It is additionally clear from FIG. 3 that some of the LEDs 22a of the front row 23 are activated and thus particular symbols 17 are illuminated. In the middle the letters HOT are illuminated, thus showing the word HOT as an indication that the hob is hot. In addition, this is further indicated by the symbols 17 taking the form of flames to the left and right of the word. Since indicating that the hob is hot is thought of as a warning, the color red or a similar signal color is here suitable for example for the illuminated LEDs 22a therebelow. Whether, in actual operation, indication that the hob is hot according to FIG. 3 is simultaneously indicated by illuminated LEDs 22a and the light strip located thereabove, which tends more to be used to display heat settings, may be individually decided and is a question of design of the display device or the underlying display method. As an alternative to signal color, indication that the hob is hot may advantageously be effected as an operating method, by flashing, in particular with an elevated or temperature-dependent frequency. As a further alternative, the temperature may be represented by the length of a light strip located thereabove. This is one of the advantages of a two-row display device according to the invention, as has been explained above, namely a larger amount of more detailed information may be provided.

FIG. 4 is a plan view of a hob 31 according to the invention. It comprises as is conventional a hob plate 32, advantageously of glass ceramic, and four rings 33a to d. The rings 33 comprise induction coils as inductive heating means, which are here not shown in any greater detail. In the front middle zone there is located an operating means 35 with touch-sensitive switches, shown by the round symbols, and the seven segment display, as is known however to a person skilled in the art. Associated with the operating means 35 is a central control unit 36 shown by broken lines. This central control unit 36 both controls the hob 31, such that it receives operating commands, which have been input at the operating means 35, and, as a function thereof, sets the operating state of the rings 33a to d. A central control unit may also be integrated in the operating unit.

FIG. 2 additionally shows two recesses 25a and 25b provided on the housing 14 to the left and right of the first row 23. These, like the light ducts 27, pass through the housing 14 and serve in the arrangement thereon of the above-stated overlap sensors and/or temperature sensors. These sensors are advantageously likewise mounted on the support 12 and electrically connected. They should be configured such that their functioning is not impaired by the cover 15 above them. Alternatively, the cover 15 should be removed in this region or be made completely light-transmitting, i.e., transparent.

In FIG. 4, connecting leads 37a to d are shown by broken lines, these extending in each case from the central control unit 36 to a display device 11a to d. They may under certain circumstances be combined with connecting cables for the heating means of the rings to form a cable harness. Alternatively, they may be looped onwards from display device to display device, i.e., form a type of loop extending from the central control unit 36 to the display devices 11 b, 11a, 11d, 11c and then back to the central control unit. The display devices 11a-11d are each arranged at the same point in front of and at roughly the same distance from the outer edge of the rings 33a to 33d, specifically below the transparent or light-transmitting hob plate 32. The display devices 11 are shown by broken lines, since they cannot themselves be detected when not illuminated or deactivated.

In the case of the display device 11c at bottom right, the light bars 29b and 29c according to FIG. 3 are illuminated, while in the display device 11d there-behind it is the light bars 29a and 29b which are illuminated. For clarity's sake, the illuminated symbols 17 over the first row 23 of LEDs 22a are not shown here in FIG. 4. With reference to FIG. 3, however, it is easy to conceive how individual ones of these symbols 17 are illuminated and then, like the seven segment display of the operating means 35, may be detected in the form of light appearing from below the hob plate 32 arranged thereover. Different modes of display or operating methods have also been described above.

FIGS. 1 and 2 do not show the above-stated spacers. They may however be provided, for example, at the four corners of the top of the housing 14, possibly also with one or more spacers therebetween over the length of the housing 14, to prevent flexure in this middle region towards the underside of the hob plate 32 extending thereover. As a result of these spacers, the cover 15 or the top thereof is at a small distance therefrom, for example around 0.5 mm. In this way, in the case of the conventionally bumpy undersides of a hob plate 32 of glass ceramic, the appearance of the illuminated symbols 17 and the light bars 29 therethrough may be optimal.

Actuation of the display devices 11 by means of the central control unit 36 as a function of inputs at the operating means 35 or as a function of the state of the rings 33a to d proceeds by way of an above-described bus system. To this end, the central control unit 36 comprises a control bus for bidirectional connection with each display device 11 or indeed for an above-described circuit connection or looping. Moreover, these connecting leads 37 also ensure power supply for operation of the LEDs 22.

1. A display device for a hob, said display device comprising a support for a plurality of illuminating means and illuminating means, said support being elongate, wherein said illuminating means are arranged so as to extend in two rows next to one another on said support, a cover being provided over at least a first said row of said illuminating means, said cover having light-transmitting zones in the form of symbols over each of said illuminating means, separators being provided between said illuminating means of said first row to prevent light from one said illuminating means from spilling over to one said light-transmitting zone above an adjacent illuminating means.

2. The display device as claimed in claim 1, wherein said illuminating means in said first row, comprises an opaque cover thereover, and are spaced from one another by a distance corresponding to two to five times an extent of said illuminating means.

3. The display device as claimed in claim 2, wherein all said illuminating means in said first row are equally spaced from one another.

4. The display device as claimed in claim 1, wherein said illuminating means in said second row, without an opaque cover thereover, are spaced from one another by a distance corresponding to two to five times an extent of said illuminating means.

5. The display device as claimed in claim 4, wherein all said illuminating means in said second row without an opaque cover thereover are equally spaced from one another.

6. The display device as claimed in claim 1, wherein said light-transmitting zones over said first row of illuminating means are configured in part as symbols and in part as letters.

7. The display device as claimed in claim 1, wherein a cover over said second row takes a form of a diffuser for said illuminating means arranged therebelow, for uniform distribution of light so that said light appears uniform.

8. The display device as claimed in claim 1, wherein said support is a component support for said illuminating means and a housing with said separators forming light ducts is positioned thereon, comprising one or more said covers that are either light-transmitting or opaque located over openings between said covers on top of said housing.

9. The display device as claimed in claim 8, wherein said housing takes the form of a grid.

10. The display device as claimed in claim 9, wherein said housing substantially surrounds said illuminating means on said support.

11. The display device as claimed in claim 1, wherein said display device or said support and said housing are of curved or arcuate construction.

12. The display device as claimed in claim 1, further comprising a control unit connecting said display device to a hob control bus for changing a status of said display as a function of control commands from a central control unit of said hob over a bus connection to said control bus, said being of bidirectional configuration.

13. The display device as claimed in claim 1, further comprising an overlap sensor in the manner of a reflection light barrier, detecting a pan positioned thereon and for outputting a corresponding warning signal.

14. The display device as claimed in claim 1, further comprising a temperature sensor detecting a hot pan positioned thereon and for outputting a corresponding warning signal.

15. The display device as claimed in claim 1, further comprising at least one seven segment display as a timer display.

16. The display device as claimed in claim 8, comprising spacers located on top of said housing.

17. The display device as claimed in claim 16, wherein said spacers protrude between 0.1 mm and 1 mm above said cover.

18. A hob having a plurality of heating means comprising individual rings and a plurality of display devices as claimed in claim 1, wherein each display device is located at a respective said heating means in a location towards a front of said hob.

19. A method of operating a display device, said display device comprising a support for a plurality of illuminating means and illuminating means, said support being elongate, wherein said illuminating means are arranged so as to extend in two rows next to one another on said support, a cover being provided over at least a first said row of said illuminating means, said cover having light-transmitting zones in the form of symbols over each of said illuminating means, separators being provided between said illuminating means of said first row to prevent light from one said illuminating means from spilling over to one said light-transmitting zone above an adjacent illuminating means, wherein, when said display device is in operation, said illuminating means in both rows are illuminated.

20. The method as claimed in claim 19, wherein different numbers of said illuminating means are illuminated.

21. The method as claimed in claim 19, wherein said illuminating means are operated with different brightness.

22. The method as claimed in claim 19, wherein in the case of a heating means said illuminating means of one said row steadily illuminates when said heating means is operated, and said illuminating means of said other row illuminates variably with different said illuminating means being switched on and off when said heating means is operated.

23. The method as claimed in claim 22, wherein said illuminating means indicates said heating means is hot after said heating means is switched off.

24. The method as claimed in claim 22, wherein said method is used to display operation of said heating means with a moving light pattern obtained by dynamic switching on and off of adjacent illuminating means.
